(19) United States
(12) Patent Application Publication
(10) Pub. No.: US 2008/0241583 A1
(43) Pub. Date: Oct. 2, 2008

(54) High Chromium Ferritic Steel With 0.5 Atomic % Hafnium, Part Of Which Is Ion Implanted

(75) Inventor: Roy Faulkner, Loughborough (GB)

Correspondence Address: SMITH-HILL AND BEDELL, P.C., 16100 NW CORNELL ROAD, SUITE 220, BEAVERTON, OR, 97006, US

(73) Assignee: LOUGHBOROUGH UNIVERSITY, Leicestershire (GB)

(21) Appl. No.: 10/599,474

(22) PCT Filed: Apr. 1, 2005
(86) PCT No.: PCT/GB2005/001280

§ 371 Date: Feb. 20, 2007

(30) Foreign Application Priority Data
Apr. 2, 2004 (GB) 0407531.3

(51) Int. Cl. B32B 15/01; C22C 38/18; C22C 1/00

(52) U.S. Cl. 428/660; 148/326; 420/590

(57) ABSTRACT

The application relates to the problem of improving the corrosion resistance and creep properties of standard Cr-steels like E911 (table 1) at high temperatures. To solve this problem, a method of adding up to 0.5 atomic % Hf both during casting or molding and by ion implantation is provided. The addition of Hf improves the corrosion resistance and creep properties inter alia, as it forms a finely distributed stable second phase and as the harmful M23C6 disappears, because all carbon is taken by Hf to form HfC.

This invention relates to a chromium alloy comprising hafnium. In particular it relates to steel comprising hafnium and a method for preparing said steel.

In recent years, much interest has been paid to the development of new alloys which would be suitable for the application in super-critical power plants. One of the methods to improve the creep property is to add micro-alloying elements. There have been a number of such kinds of study using both experimental observations and computer modelling (1, 2). For example, studies have shown that micro-additions of zirconium improve the creep resistance of chromium steels and decrease the oxidation rate sharply (3, 4). It also reduces the depletion of chromium from grain boundaries due to irradiation (5). Vodarek and Strang studied the effects of Ni on the precipitation process in a 12CrMoV steels during creep at 550° C. and found that when the content of Ni exceeds about 0.6 wt. %, the creep properties of the material will drop considerably (6).

Many studies have been carried out on the effects of hafnium on the microstructure and properties of super-alloys. Kim et al. found that addition of hafnium and carbon to a Nb—Mo—W alloy results in the formation of (Nb, Mo, Hf)C. The yield stress at 1773 K and fracture toughness at room temperature increase concurrently with increasing content of (Hf+C) in the alloy (7). Garg et al. found that small additions of Hf to conventionally processed NiAl single crystals result in the precipitation of a high density of cuboidal G-phase particles with size from 5 to about 50 nm (1 nm=10⁻⁹ m) (8).

There are as yet no known methods of using hafnium directly in the production of chromium alloys such as steel. An object of the present invention is, therefore, to provide further processes for the improvement and production of chromium alloys, such as steel.

According to a first aspect of the present invention there is provided a chromium alloy comprising hafnium.

In a preferred aspect of the invention, the chromium alloy is steel. More preferably, the steel is a stainless steel such as ferritic grade steel.

In power plant ferritic steels, high volumes of finely distributed stable second phase particles are desirable to improve the creep properties of the material at high temperature and stress. By studying the effects of hafnium on the microstructure of ferritic steels using ion implantation and modelling it has, surprisingly, been found that the invention results in a steel in which a larger number of small hafnium rich particles was formed. The steel prepared according to the invention has been found to have improved creep properties as well as an increased chromium content and thus improved corrosion resistance

Attempts have been made to increase the chromium content of chromium containing ferritic steels by directly adding more chromium into a 12% chromium ferritic steel. It was found that the microstructure of the steel began to transform to delta ferrite when the chromium content of the steel rose above 12% (Schneider. H, Foundry Trade J., 108: p. 562 (1960)). Since the alloy relies on the formation of martensite for its strength, the dilution of the martensite by the delta ferrite rapidly lead to a loss in strength of the overall alloy.

The chromium alloy may comprise up to 1 atomic(at) %, for example, up to 0.5 at % hafnium.

The chromium alloy may comprise an atomic % of carbon up to 1%, for example up to 0.5% or up to 0.4%. The hafnium may react with the carbon in the alloy to form hafnium carbide which may be in the form of hafnium carbide particles. Preferably, the hafnium, or hafnium carbide, is provided in the surface of the alloy of the invention. Thus the invention provides a chromium alloy in which hafnium is in the outer 1-2 μm of the alloy i.e. in the surface of the alloy.

Preferably, the chromium alloy of the invention is free of particles of M₂₃C₆ wherein M is an alloy of chromium with small amounts of molybdenum and iron. More preferably, the alloy of the invention comprises particles of M₂N.

The alloy of the invention may comprise less than 12 wt % chromium, for example, less than 10 wt % chromium such as 8 or 9 wt % chromium.

The alloy may contain one or more of the elements selected from Groups 3 to 16, for example, one or more of the elements selected from Groups 3 to 12. Typically, the alloy contains one or more elements selected from aluminium, molybdenum, titanium, carbon, silicon, manganese, phosphorous, sulphur, nickel, vanadium, niobium, tungsten and nitrogen. Preferably, the alloy of the invention comprises vanadium, niobium, molybdenum and nitrogen.

In a further aspect, the present invention provides a supercritical power plant comprising an alloy according to the invention. As used herein a “supercritical power plant” is intended to include, but is not limited to, a boiler operating at temperatures above 565° C.

Hafnium may be added to the steel during casting or moulding of the steel. Alternatively, powders of iron, chromium, hafnium and optionally other alloying elements may be mixed together and mechanically alloyed. The resulting powder may be then sealed in argon-containing or vacuum tight containers and then may be hot isostatically pressed and sintered at high temperature (e.g 200 C.) before being extruded into rod or bar form.

In a further aspect, the present invention provides a method for the manufacture of steel, the method comprising the steps of:
(i) addition of hafnium to steel;
(ii) heat treating the steel formed in step (i).

Preferably, the hafnium is added to steel by implantation into the steel. In a preferred embodiment of the invention, the hafnium is added to steel by ion implantation. This method has the advantage in that it allows the hafnium to dispersed homogeneously in the steel in relatively large concentrations.

The present inventors have found that in order to reduce intragranular corrosion of steel, it is sufficient to implant the hafnium in the surface of the steel. This surface modification preferably takes place in the outer 1-2 μm of the steel using ion implantation.

The heat treatment step preferably takes place at a temperature of 700-760° C. This tempering treatment may take 1 to 2 hours and may be followed by a cooling of the tempered steel

In a preferred method of the invention, up to 1.0 at % hafnium is added to the steel, for example, up to 0.5 at % hafnium.

Preferably the steel is a chromium alloy, for example, a stainless steel. The stainless steel may be ferritic grade steel. The steel may comprise less than 12wt % chromium, for example, less than 10 wt % chromium such as 8 or 9 wt % chromium. The steel may contain one or more of the elements selected from Groups 3 to 16, for example, one or more of the elements selected from Groups 3 to 12. Typically, the steel will contain one or more elements selected from aluminium, molybdenum, titanium, carbon, silicon, manganese, phosphorous, sulphur, nickel, vanadium, niobium, tungsten and nitrogen. Preferably, the steel comprises vanadium, niobium, molybdenum and nitrogen.

Preferably, the method of the invention is for the manufacture of steel suitable for use in a super critical power plants.

In a further aspect, the invention provides a method for the introduction of hafnium into steel characterised in that the hafnium is added directly to the steel by ion implantation.

A yet further aspect of the invention provides the use of hafnium in the manufacture of steel. The steel may be stainless steel such as ferritic grade steel.

In a further aspect, the invention provides steel obtainable by the method of the invention.

The present invention will now be described by way of example only with reference to the accompanying figures, wherein:

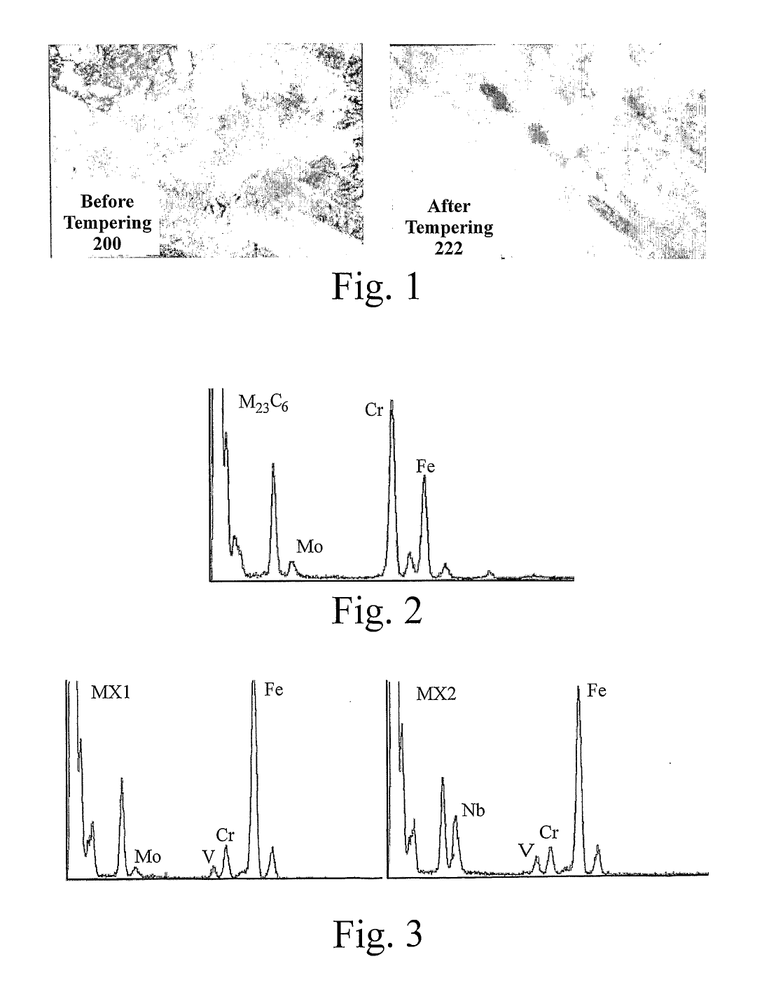

FIG. 1. Microstructures of E911 (a) at the as-received condition and (b) after tempering at 760° C. for 1 hour.

FIG. 2. Spectrum of the grain boundary precipitates in raw E911.

FIG. 3. EDX spectrum of the MX particles: (a) V rich; (b) Nb rich.

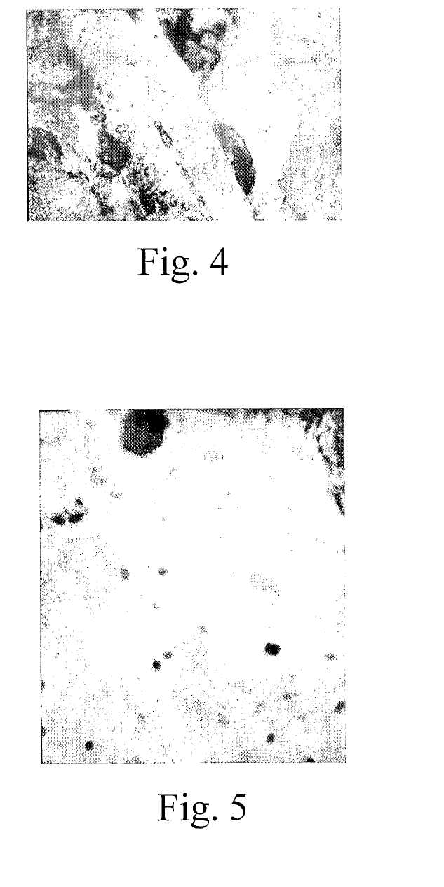

FIG. 4 TEM image of the microstructure of E911 with ˜1 at. % hafnium implantation after tempering at 760° C. for 1 hour.

FIG. 5. TEM image showing densely distributed small precipitates in Hf implanted E911 samples.

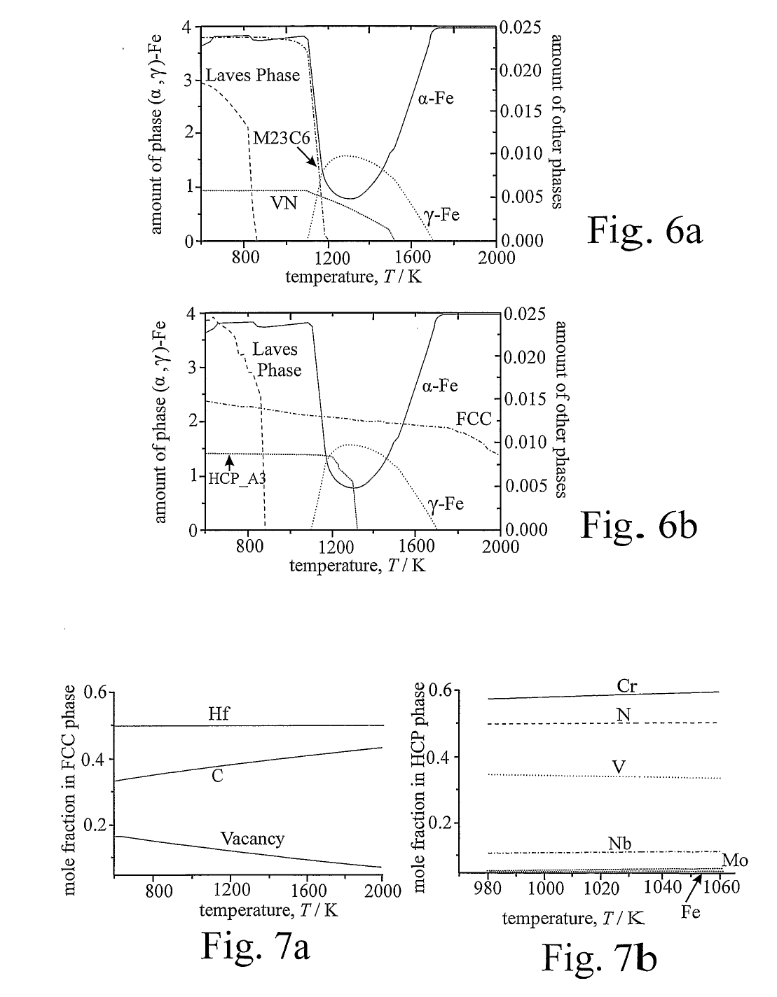

FIG. 6. Amount of equilibrium phases present in (a) raw E911 and (b) Hf implanted E911 material.

FIG. 7. Mole fraction of different elements in (a) FCC and (b) HCP_A3 phases in the Hf implanted E911 material calculated using MTDATA.

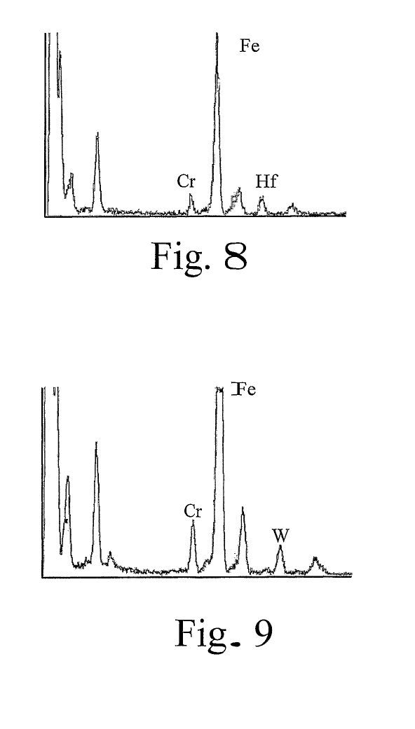

FIG. 8. EDX Spectrum of small precipitates in the E911 samples with hafnium implantation after tempering at 760° C. for 1 hour.

FIG. 9. EDX spectrum of larger precipitates in E911 samples with hafnium implantation after tempering at 760° C. for 1 hour.

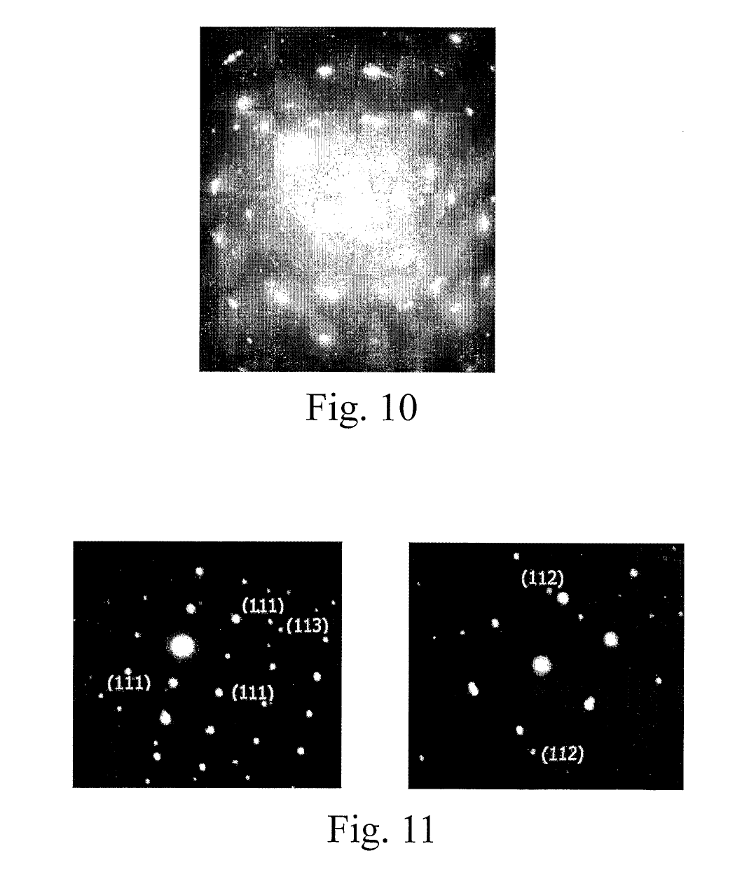

FIG. 10. Electron diffraction pattern from a small particle rich area.

FIG. 11. Electron diffraction patterns from larger particles in Hf implanted E911 samples. Same (h, k, l) values are labelled in the image.

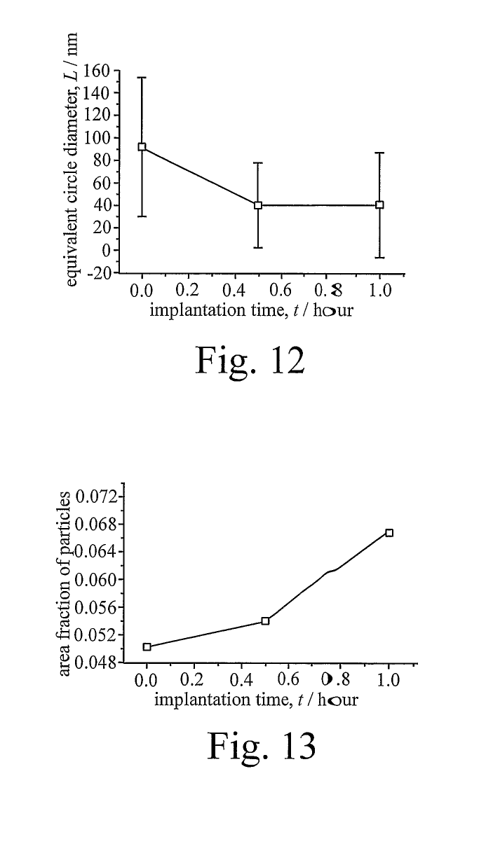

FIG. 12 Equivalent circle diameter measured from TEM images as a function of the implantation level.

FIG. 13. Measured precipitate area fraction as a function of the implanted hafnium level.

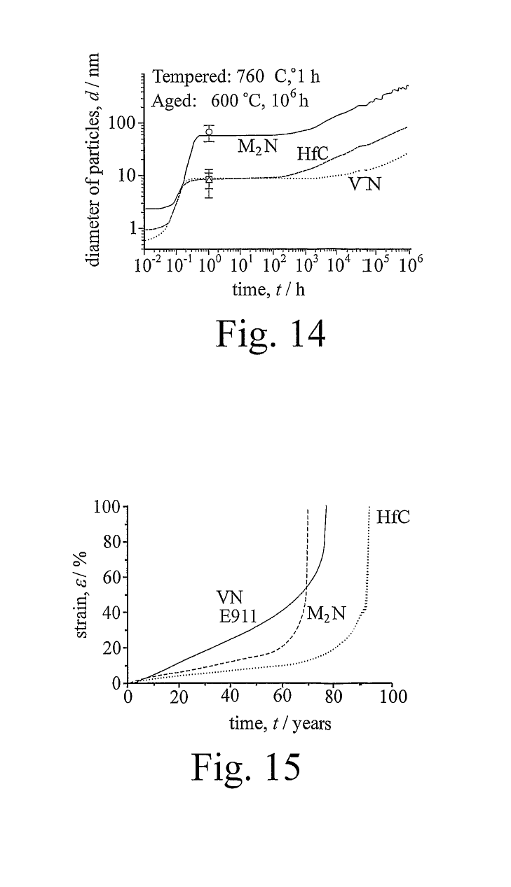

FIG. 14. Precipitation curves predicted (lines) for M₂N, HfC in the Hf implanted E911 and VN in the raw material. Symbols are measurements at the end of tempering. Circle: M₂N; Square HfC; Triangle: VN.

FIG. 15. Predicted creep curves considering the coarsening effects of second phase particles for HfC and M₂N in the Hf implanted and for VN in the raw E911 material. The temperature is 600° C. and stress is 150 MPa.

### EXAMPLE

Materials

The material used in this work is a 9 wt. % Cr ferritic steel, E911. The chemical composition of the material is shown in Table 1. The material was supplied by Corus at the as-received condition, i.e. normalised at 1060° C. for 1 hour then air cooled. Thin foils for TEM examination were cut and polished from the as-received material without any further treatment.

Ion Implantation

Ion implantation was carried out at Hokkaido University, Japan. The machine used was the ULVAC 400 kV Ion Accelerator. The hafnium target used for the implantation were manufactured by the Institute of Pure Chemicals, Japan. The purity of the hafnium target is 99.99%. The ion current was kept at about 1 μA (10⁻⁶ Amperes). The samples then were implanted for 30 and 60 minutes. These two levels of implantation is roughly equivalent to 0.5 and 1.0 at. % of Hf implantation.

Tempering and TEM

The thin foils implanted with hafnium were then tempered at 760° C. for 1 hour using the in-situ furnace in the high voltage TEM machine, JEM-ARM1300 at Hokkaido University, Japan. The samples were heated to the tempering temperature for around five minutes, and then kept at this temperature for 1 hour. After cooling down in the furnace, TEM pictures of the microstructure of the samples were then taken for the measurement of particle size and volume fraction using the image analysis software, Image-Pro Plus. Compositional determination of the particles were carried out using the FEI Tecnai F20 Field Emission Gun Transmission Electron Microscope. Electron diffraction patterns were taken using JEOL JEM 100CX TEM.

### Results and Discussion

Microstructure of the Material Without Addition of Hafnium

The microstructure of the as-received material is shown in FIG. 1(a). As expected, the as-received material shows a clear lath structure without any profound evidence of precipitation. The width of the laths is a few hundred nanometres. After tempering, two kinds of precipitates formed. One is mainly located at the grain boundaries with the elongated axis along the grain boundaries, and the others are mainly in the matrix and are with spherical morphology and they are much smaller than the grain boundary precipitates (see FIG. 1(b)). The EDX spectrum of the grain boundary particles is shown in FIG. 2. It is clear that the grain boundary precipitates are a chromium rich phase, though the spectrum is influenced by the matrix composition. Therefore, it is concluded that they are M₂₃C₆ particles which are found in most ferritic steels and are located mainly at grain boundaries. It is also clear that there is a small amount of molybdenum in these grain boundary precipitates.

The smaller, and intra-granular particles are thought to be MX particles as in most ferritic steels. Two types of MX particles were found in the tempered E911 samples. These EDX spectra are shown in FIG. 3. In one type of the particles, there is a sound evidence of the presence of vanadium. In recognising that the spectrum is very likely to be much noise by the matrix and that the distortion by the matrix is more severe in the case of small particles, we are confident that these are VN or V(C,N) particles. In the other type of small particles, there is a clear indication of a high content of vanadium. However, the content of niobium in these particles is much higher than that of vanadium. Therefore, these are (Nb, V) C or (Nb, V) (C,N) precipitates. These observations are in very good agreement with reports in the literature (8).

Microstructure of the Material With Implantation of Hafnium

The microstructure of the hafnium implanted E911 after tempering at 760° C. for 1 hour is shown in FIG. 4. The difference between the microstructure of the Hf implanted and raw E911 samples is clear. Firstly, here there are an enormous number of small particles, as clearly shown in FIG. 5. Secondly, the larger particles are not only along grain boundaries, but can be found in the matrix as well. Therefore, it is concluded that some kind of new phase maybe formed with the implantation of Hf as compared to the raw material.

MTDATA Calculations.

In order to determine the phases present in the Hf implanted material, MTDATA (10, 11) was used to determine the equilibrium phases. FIG. 6 shows the calculated amount of different phases present in both (a) the raw material and (b) the Hf implanted material, as a function of temperature. At the tempering temperature employed in this study, i.e. 1033 K, there are mainly three phases in the raw material, they are α-Fe, M₂₃C₆ and VN. This is in very good agreement with experimental observations as discussed above. Comparing FIG. 6(b) with (a), the M23C6 phase has disappeared. Instead, a new phase, HCP_A3 presents. This phase can exist to a higher temperature than M23C6. Another FCC phase is also present, but it is not VN any more, because its dissolution temperature is much high than that of VN.

The composition of the FCC phase according to MTDATA as a function of temperature is shown in FIG. 7(a). The atomic fraction of Hf is 0.5 at the tempering temperature and is nearly a constant at different temperatures. The atomic fraction of carbon varies from 0.33 to 0.43 and has a value of 0.37 at the temperature employed in this study. The phase also contains from 0.07 to 0.17 atomic fraction of vacancies. These atomic fraction values clearly suggest that the FCC phase is HfC with a substantial fraction of the carbon sites unoccupied. This also explains the disappearance of M₂₃C₆ particles from the Hf implanted material. Because the high amount of Hf implanted (0.5 to 1.0 at. %) and the carbon content in the material is much lower than that of Hf, all carbon is taken by Hf to form HfC. This supports the observation that that Hf is a stronger carbide former than Cr.

FIG. 7(b) shows the composition of the HCP_A3 phase as a function of temperature. It is clear that phase mainly contains Cr, V, Nb, Mo and N. The atomic fraction of N is about ⅓. Therefore, this new phase has a composition of M₂N, which is similar to the commonly known Z-phase (CrNbN) (12). The difference is that Z-phase has a tetragonal rather than hexagonal structure. We believe that this phase is a variant of the Cr₂N phase which also has a hexagonal crystal structure. However, as the Z-phase is not included in the databases used in MTDATA, we can not exclude the possibility that this phase is the Z-phase. It is also clear that there are few VN particles because most of the nitrogen has been taken by the new M₂N phase.

EDX Studies

The composition of the particles present in the Hf implanted E911 material was also studied using TEM. A typical EDX spectrum taken from small particles in the material is shown in FIG. 8. As it can be seen from the figure, there is clear evidence for the presence of Hf in these small particles. Because the particles are very small (diameter less than 10 nm), the spectrum contains a very high contribution from the matrix. From this, we can conclude that the small particles in the material are Hf rich.

FIG. 9 shows an example of the EDX spectrum from the larger particles present in the Hf implanted E911 samples. The content of Cr in these particles is much lower than that in M₂₃C6 particles in the raw material (cf. FIG. 2). This indicates that these particles are most probably not M₂₃C₆ precipitates. It is also clear that the larger particles do not contain an appreciable amount of Nb, as is the case in the Z-phase. Thus the larger particles may be not the Z-phase.

In summary, EDX studies show that there is a fine Hf rich phase and a distribution of larger precipitates which are not M₂₃C₆ particles present in the Hf implanted material. This is in a very good agreement with the MTDATA calculations discussed in the previous section.

Electron Diffraction Patterns

Electron diffraction patterns from the small particles are very difficult to take, because they are below the equipment's resolution limit. Therefore, diffraction patterns were taken from areas where there are many small particles, such as the area shown in FIG. 5. An example is shown in FIG. 10. Due to the diffraction from the matrix and other particles, the diffraction pattern is very noisy and it is very difficult to identify the spots corresponding to specific phases. However, it is also clear that there is some sort of ring structure in the pattern. X-ray standard diffraction data for HfC was used to fit the corresponding d-values from the pattern shown in FIG. 10. It was found that most of the d-values listed in the X-ray diffraction data for HfC can be matched. In combination with the results from EDX analysis and MTDATA calculations, it is concluded that the small particles present in the Hf implanted E911 material are HfC.

Electron diffraction patterns from the larger particles in Hf implanted E911 samples are shown in FIG. 11. Because the size of the particles is much larger (˜65 nm in diameter) than HfC particles, the diffraction patterns are cleaner. A similar approach to that of determining the structure of HfC particles was taken. Table 2 lists the d values of (Cr,Fe)₂N₁₋ₓ from x-ray diffraction, compared with d values found from electron diffraction patterns obtained in this study. Clearly, all the values of d listed in the diffraction data card are matched reasonably well, especially the strongest lines are matched very well. The electron diffraction patterns from the larger particles are also analysed against diffraction data of Z-phase, as shown in Table 3. It is clear that a substantial proportion of the d values listed in the standard x-ray diffraction data card have not been matched. In addition, these un-matched d values include a few of the strong diffraction lines from x-ray diffraction. Therefore, it is more likely that these larger particles are hexagonal M₂N rather than Z-phase. Considering the fact that the EDX from these particles does show an appreciable amount of Nb, as it is the case in Z-phase (CrNbN), we conclude that the larger particles in Hf implanted E911 material are hexagonal M₂N.

From above discussions, it is clear that Hf has very significant effects on the microstructure of E911 material. Firstly it prevents the formation of the M₂₃C₆ particles present in the raw materials by forming a FCC structured HfC, which takes most of the carbon in the material. According to our creep modelling calculations, M₂₃C₆ coarsens very fast and thus accelerates creep damage considerably. From this point of view, the removal of M₂₃C₆ by the formation of HfC is very beneficial for the creep properties of the material. Secondly, two new phases are formed: HfC and M₂N. Because most of the nitrogen has been taken by the M₂N phase, there are few VN particles. Because of the smaller size of the M₂N compared to that of M₂₃C₆ particles in the raw materials (˜90 nm in diameter) and because M₂N is distributed everywhere rather than mainly along grain and lath boundaries, it is believed that M₂N would be better for the creep properties of the material than M₂₃C₆. HfC is expected to have similar behaviour to VN. However, as the volume fraction of HfC (˜1.9%) is much higher that of VN in the raw material (˜0.3%), it may also lead to improvements in the creep behaviour of the material.

Another important effect of Hf on the microstructure of E911 is that it will increase the Cr content in the matrix and thus at the grain boundaries. From the volume fractions of M₂N in the Hf implanted material and of M₂₃C₆ in the raw material and the Cr content in those two phases, it can be calculated that the matrix content of Cr would increase by about 1 at. % when M₂₃C₆ is replaced by M₂N due to the addition of Hf. This would improve the corrosion resistance property of the material considerably.

Effects of Hafnium Implantation on Precipitate Size and Volume Fraction

As discussed above, the implantation of hafnium introduced a large number of very small particles in the material. Therefore, it has a considerable effect on the overall average size and volume fraction of the particles. FIGS. 12 and 13 show the effect of the hafnium implantation level on the average precipitate size and volume fraction.

The average particle size was measured as the equivalent circle diameter, i.e. the diameter of a circle with the same area. The level of implantation is presented as implantation time with 1 hour is roughly equivalent to 1.0 at. % of implantation. It is clear that the addition of hafnium reduces the average size of the precipitates considerably, because of the formation of a large number of smaller hafnium rich particles. The higher the concentration of hafnium, the smaller the average particle size. However, the reduction in particle size when the implantation level exceeds 0.5 at. % is less marked. The overall reduction of average particle size is more than 50%.

The volume fraction of the precipitates was measured as the area fraction of the particles. It is easy to understand that this may not be the representation of the true volume fraction of the particles in the material as here we are sampling a volume of the material. However, the area fraction is an indicator of the true volume fraction of the particles. The area fraction of the particles is presented in FIG. 13 as a function of implantation time. It is clear that the addition of hafnium increases the total volume fraction of the precipitates considerably.

It is believed that a substantial volume fraction of fine distributed second phase particles would improve the creep behaviour of power plant ferritic steels at high temperatures. From FIGS. 12 and 13, it is concluded that the addition of hafnium to power plant ferritic steels would achieve this.

Precipitation and Creep Behaviour of HfC and M₂N

In order to look at the long term effect of the two new phases created by the introduction of Hf into the E911 material, precipitation kinetics of both new phases were simulated using our newly developed model (13, 14), the effect of these phases on the creep behaviour was modelled using the Continuum Creep Damage Mechanics (CDM) model¹⁵ and the results were compared with that of VN in the raw material.

FIG. 14 shows the predicted precipitation kinetics of M₂N and HfC particles in the Hf implanted E911 material, tempered at 760° C. for 1 hour then aged at 600° C. for up to 1000,000 hours. To facilitate comparison, the predicted precipitation curve of VN in the raw E911 material with the same heat treatment conditions, is also presented. Symbols are experimental measurements of the particle size at the end of tempering. Generally speaking, the model predictions agree with the measurements. Both HfC and M₂N coarsen faster than VN in the raw material. This is because that both phases have much higher volume fraction than VN, thus smaller inter-particle spacing. Therefore, the diffusion of solute atoms between the particles is easier. Nevertheless, for the same reason, the material with HfC and M₂N has better creep behaviour than that with VN particles within the normal life time scale of the material as predicted using CDM modelling. This is clearly shown in FIG. 15, where predicted creep curves for all the three types of particles are shown.

Conclusions

The implantation of hafnium to E911 has significant effects on the microstructure of Fe-9Cr steel. Hafnium enters a new precipitate phase, which is very finely distributed hafnium carbide with spherical shape. The particle density of the hafnium carbide is huge. M₂₃C₆ particles which normally exist in power plant steels are not present in the Hf implanted material, due to most of the carbon atoms being taken by the hafnium carbide. This indicates that Hf can prevent the formation of M₂₃C₆ particles. Instead of the chromium rich phase M₂₃C₆, a new chromium rich hexagonal phase, M₂N, forms in the Hf implanted material. These particles have diameters of about 65 nm and are distributed homogeneously in the material rather than along the grain boundaries. The replacement of M₂₃C₆ particles by the M₂N phase increases the matrix chromium level by nearly 1 at. %, resulting in an increase in the corrosion resistance of the implanted material. Implantation of Hf to E911 results in a marked decrease in the overall average size of the precipitates and a increase in the volume fraction of the second phase particles. The long term precipitation behaviour of the two new phases is similar, but coarsening faster than VN in the raw material. However, their presence will improve the material's creep behaviour significantly as predicted by the CDM modelling due to their much higher volume fraction as compared to VN.

### REFERENCES

1. H. Okada, S. Muneki, K. Yamada, H. Okubo, M. Igarashi, and F. Abe: ISIJ INTERNATIONAL, 2002, 42,1169-1174.
2. Y. F. Yin, and R. G. Faulkner: Materials Science and Engineering A, 2003, 344, 92-102.
3. A. V. Ryabchenkov, V. A. Tarzhumanova, and S. A. Yuganova: Materials Science and Heat Treatment, 1985, 27, 756-759.
4. V. A. Repin, L. I. Shvedov, G. V. Volkov, and V. V. Suprunenk: STEEL IN THE USSR, 1991, 21, 237-239.
5. N. Shigenaka, S. Ono, Y. Isobe, T. Hashimoto, H. Fujimori, and S. Uchida: Journal of Nuclear Science and Technology, 1996, 33, 577-581.
6. V. Vodarek, and A. Strang: SCRIPTA MATERIALIA, 1997,38,101-106.
7. W. Y. Kim, H. Tanaka, M. S. Kim, and S. Hanada: Materials Science and Engineering A, 2003, 346, 65-74.
8. A. Garg, R. D. Noebe, and R. Darolia: Acta Materialia, 1996, 44, 2809-2820.
9. P. J. Ennis, and A. Czyrska-Filemonowicz: OMMI, 2002, 1, 1-28.
10. R. H. Davies et al., Proc. Conf ASM/TMS Fall meeting on ‘Applications of thermodynamics in the synthesis and processing of materials’, Rosemont, Ill., USA, October 1994, 371-384.
11. R. H. Davies, A. T. Dinsdale, T. G. Chart, T. I. Barry, and M. H. Rand: High Temperature Science, 1990, 26, 251-262.
12. T. Sourmail: Materials Science and Technology, 2001, 17, 1-14.
13. Y. F. Yin, and R. G. Faulkner: Materials Science and Technology, 2003, 19, 91-98.
14. Y. F. Yin, and R. G. Faulkner: In ‘Power Technology’, (ed. J. Lecomte-Beckers et al.), Vol. 21, 1247-1256; 2002, Jülich: Forschungszentrum Jülich GmbH.
15. B. Dyson: Journal of Pressure Vessel Technology, 2000, 122, 281-296.

TABLE 1
Chemical composition of E911 (wt. %, Fe balance)

| C | Si | Mn | P | S | Cr | Mo | Ni | V | Al | Nb | W | N |
|---|---|---|---|---|---|---|---|---|---|---|---|---|
| 0.115 | 0.19 | 0.35 | 0.007 | 0.003 | 9.10 | 1.00 | 0.22 | 0.23 | 0.006 | 0.069 | 0.98 | 0.069 |

TABLE 2
X-ray diffraction data of HfC compared with the d values
found from the electron diffraction patterns obtained here.

| | |
|---|---|
| Data from x-ray | Matched |
| diffraction card | Error |

| d/Å | I/I₁ | hk1 | d/Å | (%) |
|---|---|---|---|---|
| 2.68 | 100 | 111 | | |
| 2.321 | 90 | 200 | 2.33 | 0.39 |
| 1.641 | 70 | 220 | 1.645 | 0.25 |
| 1.399 | 80 | 311 | 1.396 | −0.22 |
| 1.340 | 30 | 222 | 1.32 | −1.5 |
| 1.160 | 10 | 400 | 1.17 | 0.87 |
| 1.065 | 50 | 331 | 1.06 | −0.47 |
| 1.038 | 50 | 420 | | |
| 0.9473 | 40 | 422 | 0.960 | 1.4 |
| 0.8932 | 50 | 333, 511 | | |
| 0.8204 | 30 | 440 | | |
| 0.7845 | 80 | 531 | | |
| 0.7735 | 70 | 600 | | |

TABLE 3
X-ray diffraction data of (Cr,Fe)₂N₁₋ₓ compared with the d values
found from the electron diffraction patterns obtained here.

| | |
|---|---|
| Data from x-ray | Matched |
| diffraction card | Error |

| d/Å | I/I₁ | hk1 | d/Å | (%) |
|---|---|---|---|---|
| 2.399 | 16 | 110 | 2.3572 | −1.8 |
| 2.233 | 40 | 002 | 2.174 | −2.7 |
| 2.114 | 100 | 111 | 2.1191 | 0.25 |
| 1.634 | 35 | 112 | 1.639 | 0.31 |
| 1.387 | 25 | 300 | 1.399 | 0.87 |
| 1.266 | 30 | 113 | 1.264 | −0.16 |
| 1.178 | 20 | 302 | 1.174 | −0.34 |
| 1.159 | 16 | 221 | 1.174 | 1.3 |
| 1.115 | 10 | 004 | 1.081 | −3.1 |
| 1.054 | 8 | 222 | 1.081 | 2.6 |
| 1.013 | 8 | 303 | 1.002 | −1.1 |
| 0.9342 | 35 | 223 | 0.9336 | −0.07 |

TABLE 4
X-ray diffraction data of Z-phase (CrNbN) compared with the
d values found from the electron diffraction patterns obtained here.

| | |
|---|---|
| Data from x-ray | Matched |
| diffraction card | Error |

| d/Å | I/I₁ | hk1 | d/Å | (%) |
|---|---|---|---|---|
| 7.380 | 1 | 001 | | |
| 3.650 | 3 | 002 | | |
| 2.803 | 8 | 101 | 2.779 | −0.9 |
| 2.461 | 25 | 003 | | |
| 2.344 | 55 | 102 | 2.357 | 0.6 |
| 2.144 | 40 | 110 | 2.152 | 0.4 |
| 2.051 | 1 | 111 | 2.098 | 2.3 |
| 1.913 | 18 | 103 | 1.899 | −0.8 |
| 1.853 | 3 | 112 | 1.890 | 2.0 |
| 1.847 | 15 | 004 | 1.840 | −0.4 |
| 1.618 | 40 | 113 | 1.639 | 1.3 |
| 1.578 | 10 | 104 | 1.566 | −0.8 |
| 1.518 | 35 | 200 | 1.554 | 2.4 |
| 1.491 | 1 | 201 | | |
| 1.478 | 18 | 005 | | |
| 1.403 | 1 | 202 | 1.399 | −0.4 |
| 1.400 | 30 | 114 | 1.399 | −0.1 |
| 1.336 | 17 | 211 | 1.399 | 4.7 |
| 1.329 | 55 | 105 | | |
| 1.292 | 40 | 203 | | |
| 1.275 | 100 | 212 | | |
| 1.231 | 7 | 006 | | |
| 1.218 | 65 | 115 | 1.174 | −3.7 |
| 1.189 | 40 | 213 | 1.174 | −1.3 |
| 1.175 | 50 | 204 | 1.174 | −0.1 |

1-38. (canceled)

39. A chromium steel alloy including hafnium and carbon, in which the relative proportions of hafnium and carbon are such that substantially all of the carbon is present as hafnium carbide.

40. An alloy according to claim 39, in which substantially no amount of phase M23C6 is present.

41. An alloy according to claim 39, in which the portion of hafnium is at least stoichiometrically equal to the proportion of carbon.

42. An alloy according to claim 39, in which the proportion of hafnium is at least 0.5 atomic %.

43. An alloy according to claim 39, in which the hafnium level is between 0.5 and 1.0 atomic %.

44. An alloy according to claim 39, in which the alloy includes a plurality of particles of different sizes and the hafnium carbide is present in the form of a plurality of relatively small precipitate particles which reduce the average particle size in comparison with a similar alloy without hafnium.

45. An alloy according to claim 39, in which the average particle size measured as an equivalent circle diameter is less than 90 nm.

46. An alloy according to claim 39, in which the said average particle size is less than 50 nm.

47. An alloy according to claim 39, in which the hafnium is substantially only present in a surface layer.

48. An alloy according to claim 39, in which the surface layer is up to 2 μm in thickness.

49. An alloy according to claim 39, in which the alloy has been heat treated, and the heat treatment takes place after the addition of hafnium to the alloy.

50. An alloy according to claim 39, in which the alloy has been heat treated to a temperature of 700-760° C.

51. An alloy according to claim 39, in which the alloy has been heat treated for 1 to 2 hours.

52. An item formed of a chromium steel alloy including hafnium and carbon, in which the relative proportions of hafnium and carbon are such that substantially all of the carbon is present as hafnium carbide.

53. An item according to claim 52, in which the alloy includes hafnium and the hafnium is substantially only present in a surface layer.

54. An item according to claim 52, in which the alloy includes hafnium, and the hafnium is substantially only present in a surface layer which is up to 2 μm in thickness.

55. An item according to claim 52, in which the alloy includes hafnium and the hafnium is substantially only present in a surface layer which is between 1 and 2 μm in thickness.

56. A method of manufacturing a chromium steel alloy including hafnium and carbon, in which the relative proportions of hafnium and carbon are such that substantially all of the carbon is present as hafnium carbide, the method including the steps of adding hafnium to a chromium steel alloy, and then heat treating the resulting alloy.

57. A method according to claim 56, in which the alloy is heat treated to a temperature of 700-760° C.

58. A method according to claim 56, in which the heat treatment is for 1 to 2 hours.

59. A method according to claim 56, in which the hafnium is added so that the hafnium is only present in a surface layer.

60. Use of hafnium as an ingredient in a chromium steel alloy according to claim 39 to reduce creep.

61. Use of hafnium as an ingredient in a chromium steel alloy according to claim 39 to increase corrosion resistance.
